(19) United States
(12) Patent Application Publication
(10) Pub. No.: US 2009/0052207 A1
(43) Pub. Date: Feb. 26, 2009

(54) LIGHT SOURCE MODULE OF SCANNING DEVICE

(76) Inventors: Ching-Chung CHEN, Taipei Hsien (TW); Yen-Chun Chou, Taipei City (TW)

Correspondence Address: SINORICA, LLC, 528 FALLSGROVE DRIVE, ROCKVILLE, MD, 20850, US

(21) Appl. No.: 11/964,492

(22) Filed: Dec. 26, 2007

(30) Foreign Application Priority Data
Aug. 23, 2007 (TW) 096131288
Aug. 30, 2007 (CN) 200710147979.5

(51) Int. Cl. F21V 7/04

(52) U.S. Cl. 362/616

(57) ABSTRACT

A light source module of scanning device includes a first light guide rod, a second light guide rod, and a light emitting diode. The first light guide rod has a first incident surface and is disposed at a first end portion. The second light guide rod has a second incident surface and is disposed at a second end portion. The light emitting diode is disposed between the first end portion and the second end portion.

### CROSS REFERENCE TO RELATED APPLICATIONS

This Non-provisional application claims priority under 35 U.S.C. §119(a) on Patent Application No(s). 096131288 filed in Taiwan, Republic of China on Aug. 23, 2007, the entire contents of which are hereby incorporated by reference.

### BACKGROUND OF THE INVENTION

1. Field of Invention

The invention relates to a light source module and, in particular, to a light source module of a scanning device.

2. Related Art

Data image inputs of modem scanners, fax machines, copy machines, or multi-function peripherals require the use of light sources during the scanning process. Therefore, the light-emitting efficiency, stability and starting time of the light source are closely related to the overall quality and performance of the scanning device.

As shown in FIG. 1, a conventional scanning device 1 includes an image sensor 11, a light source 12 and a transparent supporting plate 13. The scanning device 1 is a scanner. The image sensor 11 is a charge-coupled device (CCD). The transparent supporting plate 13 is a glass supporting plate. The light source 12 is a cold-cathode fluorescent lamp (CCFL), a linear light source, and disposed between the transparent supporting plate 13 and the image sensor 11. When the scanning device 1 scans a document 14 is disposed on the transparent supporting plate 13, the light emitted by the light source 12 scans through the surface of the document 14 for the image sensor 11 to receive the light reflected by the document 14. This completes the scanning process of the scanning device 1.

However, using the CCFL as the light source 12, the starting time and light-emitting efficiency of the conventional scanning device 1 are worse than the scanning device using the light-emitting diode (LED) as the light source.

Therefore, it is an important subject to provide a light source module of a scanning device that has a shorter starting time and an enhanced light-emitting efficiency to increase the overall scanning speed and quality of the scanning device.

### SUMMARY OF THE INVENTION

In view of the foregoing, the invention is to provide a light source module of a scanning device that has a shorter starting time and a longer lifetime so as to increase the overall scanning speed and quality of the scanning device.

To achieve the above, the invention discloses a light source module of a scanning device. The light source module includes a first light guide rod, a second light guide rod and a light-emitting diode (LED). The first light guide rod has a first incident surface at a first end portion. The second light guide rod has a second incident surface at a second end portion. The LED is disposed between the first end portion and the second end portion.

As mentioned above, the light source module of a scanning device the LED according to the invention is disposed between the end portions of the two light guide rods so that light emitted by the LED becomes uniform after passing through the light guide rods. It can replace the conventional cold cathode fluorescent lamp. In comparison with the prior art, the light source module of the invention has better light-emitting efficiency, shorter starting time and longer lifetime. Therefore, the overall scanning speed and quality of the scanning device can be increased.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic view of a conventional scanning device and a conventional light source thereof;

FIG. 2 is a schematic view of a light source module of a scanning device according to a first embodiment of the invention; and

FIG. 3 is a schematic view of a light source module of a scanning device according to a second embodiment of the invention.

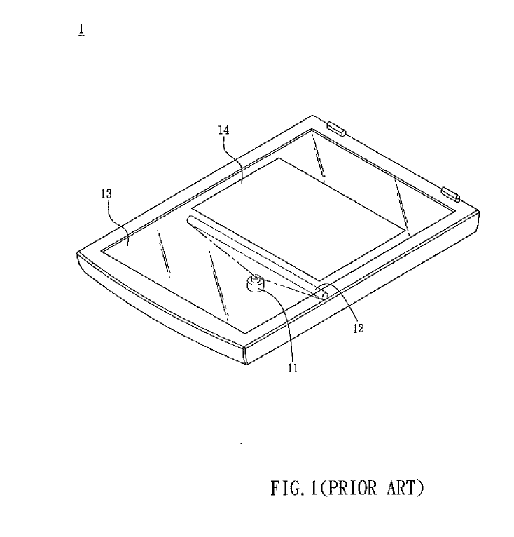

### DETAILED DESCRIPTION OF THE INVENTION

The present invention will be apparent from the following detailed description, which proceeds with reference to the accompanying drawings, wherein the same references relate to the same elements.

### First Embodiment

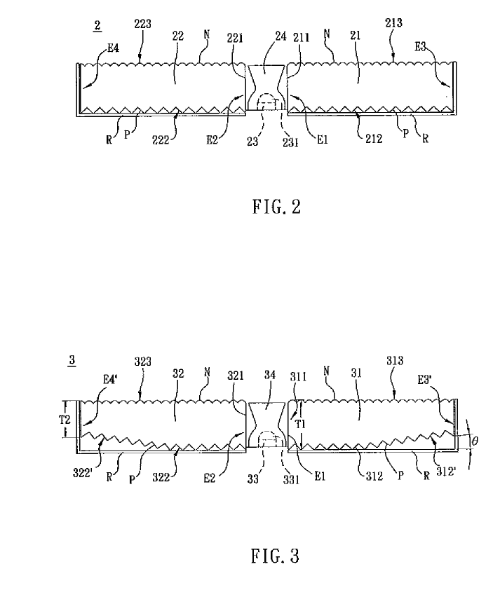

With reference to FIG. 2, a light source module 2 of a scanning device according to a first embodiment of the invention includes a first light guide rod 21, a second light guide rod 22 and a light emitting diode (LED) 23. The first light guide rod 21 and the second light guide rod 22 can be rectangular or wedge-shaped light guide rods with a flat bottom surface or an arc-shaped light guide rod with an arc bottom surface. In this embodiment, the first light guide rod 21 and the second light guide rod 22 are rectangular and disposed in a straight line. The first light guide rod 21 has a first incident surface 211 at a first end portion E1. The second light guide rod 22 has a second incident surface 221 at a second end portion E2. The first end portion E1 and the second end portion E2 are disposed opposite to each other.

The LED 23 can be an LED element or a die disposed between the first end portion E1 and the second end portion E2. In this embodiment, in addition to a molding 231 on the LED 23, the light source module 2 further includes a light guide lens 24 covering the LED 23 so that the light is emitted from both sides.

The first light guide rod 21 has a third end portion E3 disposed opposite to the first end portion E1. The second light guide rod 22 has a fourth end portion E4 disposed opposite to the second end portion E2. In addition, the first light guide rod 21 further has a first bottom surface 212 and a first light-emitting surface 213 disposed opposite to each other. The second light guide rod 22 further has a second bottom surface 222 and a second light-emitting surface 223 disposed opposite to each other.

The first bottom surface 212 and the second bottom surface 222 can have several prisms P, at least one Fresnel lens (not shown) or several mesh points. The first light-emitting surface 213 and the second light-emitting surface 223 can have several lenticular lenses N, several convex and/or concave portions. In this embodiment, the first light-emitting surface 213 and the second light-emitting surface 223 have several lenticular tenses N. The first bottom surface 212 and the second bottom surface 222 have several prisms P disposed in parallel. It should be noted that according to the design requirements, at least some of the prisms P have different vertex angle and groove depth. Moreover, the light source module 2 includes a reflective sheet R disposed adjacent to the first bottom surface 212 and the third end portion E3 of the first light guide rod 21 and the second bottom surface 222 and the fourth end portion E4 of the second light guide rod 22.

The light emitted by the LED 23 enters the first light guide rod 21 and the second light guide rod 22 via the first incident surface 211 and the second incident surface 221, respectively. After the reflection of the prisms P disposed on the first bottom surface 212 and the second bottom surface 222, the light leaves via the first light-emitting surface 213 and the second light-emitting surface 223. Since the first light-emitting surface 213 and the second light-emitting surface 223 have lenticular lenses N, the outgoing light is uniform.

### Second Embodiment

With reference to FIG. 3, a light source module 3 of a scanning device according to a second embodiment of the invention includes a first light guide rod 31, a second light guide rod 32 and an LED 33. The difference between this embodiment and the first embodiment is in that the first light guide rod 31 and the second light guide rod 32 are wedge-shaped light guide rods. The thickness T1 of the first end portion E1 and the second end portion E2 is greater than the thickness T2 of the third end portion E3′ and the fourth end portion E4′. Moreover, the first light guide rod 31 has a third bottom surface 312′, subtending an angle θ with the first bottom surface 312. The second light guide rod 32 has a fourth bottom surface 322′, subtending an angle θ with the second bottom surface 322. The angle θ is preferably smaller than 5 degrees.

In summary, the light source module of a scanning device the LED according to the invention is disposed between the end portions of the two light guide rods so that light emitted by the LED becomes uniform after passing through the light guide rods. It can replace the conventional cold cathode fluorescent lamp. In comparison with the prior art, the light source module of the invention has better light-emitting efficiency, shorter starting time and longer lifetime. Therefore, the overall scanning speed and quality of the scanning device can be increased.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light source module of a scanning device, comprising:
a first light guide rod having a first incident surface at a first end portion;
a second light guide rod having a second incident surface at a second end portion; and
a light emitting diode (LED) disposed between the first end portion and the second end portion.

2. The light source module of claim 1, wherein the first light guide rod has a third end portion disposed opposite to the first end portion, and the second light guide rod has a fourth end portion disposed opposite to the second end portion.

3. The light source module of claim 1, wherein the thicknesses of the first end portion and the second end portion are greater than the thicknesses of the third end portion and the fourth end portion, respectively.

4. The light source module of claim 1, wherein the first light guide rod further has a first bottom surface, and the second light guide rod further has a second bottom surface.

5. The light source module of claim 4, wherein the first light guide rod further has a third bottom surface subtending an angle with the first bottom surface.

6. The light source module of claim 4, wherein the second light guide rod further has a fourth bottom surface subtending an angle with the second bottom surface.

7. The light source module of claim 4 further comprising:
a reflective sheet disposed adjacent to the first bottom surface of the first light guide rod and the second bottom surface of the second light guide rod.

8. The light source module of claim 4, wherein the first light guide rod further has a first light-emitting surface disposed opposite to the first bottom surface, and the second light guide rod further has a second light-emitting surface disposed opposite to the second bottom surface.

9. The light source module of claim 8, wherein each of the first light-emitting surface and the second light-emitting surface has a plurality of lenticular lenses, a plurality of convex and/or a plurality of concave portions.

10. The light source module of claim 4, wherein the first bottom surface and the second bottom surface have a plurality of prisms, at least one Fresnel lens or a plurality of mesh points.

11. The light source module of claim 10, wherein vertex angles of the prisms are different.

12. The light source module of claim 10, wherein groove depths of the prisms are different.

13. The light source module of claim 1 further comprising:
a light guide lens covering the LED.
